(19) United States
(12) Patent Application Publication
(10) Pub. No.: US 2025/0219244 A1
(43) Pub. Date: Jul. 3, 2025

(54) COATED BATTERY SEPARATOR COMPRISING POROUS POLYMERIC COATING, AND BATTERY COMPRISING THE SAME

(71) Applicant: Celgard, LLC, Charlotte, NC (US)

(72) Inventors: Wenbin Yin, Charlotte, NC (US); Zhengming Zhang, Rock Hill, SC (US)

(21) Appl. No.: 18/853,382

(22) PCT Filed: Apr. 7, 2023
(86) PCT No.: PCT/US2023/017804

§ 371 Date: Oct. 1, 2024

Related U.S. Application Data
(60) Provisional application No. 63/329,183, filed on Apr. 8, 2022.

(51) Int. Cl. H01M 50/414; H01M 50/434; H01M 50/446; H01M 50/449

(52) U.S. Cl. CPC H01M 50/414; H01M 50/434; H01M 50/446; H01M 50/449

(57) ABSTRACT

A coated battery separator, comprising the battery separator; and a porous coating on at least one side of the battery separator, wherein the porous coating comprises a polymer comprising an amide functional group.

### RELATED APPLICATION DATA

This Application is a 371 U.S. Application which claims priority to PCT Application No. PCT/US2023/017804, filed Apr. 7, 2023, which claims priority to U.S. Provisional Application No. 63/329,183, filed Apr. 8, 2022, and is incorporated herein in its entirety.

### FIELD

This application is directed to a coated battery separator that comprises a porous polymeric coating. The polymer in the porous polymeric coating has a high thermal decomposition temperature. For example, the decomposition temperature may be greater than 200° C., 250° C., 300° C., 350° C., or 400° C. When used in a secondary battery, this provides, among other things, heat stability when the battery overheats.

### BACKGROUND

Celgard was the first to provide a ceramic-coated separator, which dramatically increased the safety of lithium ion batteries. See Celgard's seminal patent U.S. Pat. No. 6,432,586, now U.S. RE 47,520. At high temperatures, ceramic-coated separators may shrink unless a thick coating is provided. Shrinkage of the separator in a battery could lead to exposure of the electrodes to one another, short-circuiting, thermal runaway, and even explosion.

In the lithium-ion battery market, there is a desire for battery separators to be thinner. When thinner battery separators are used, capacity may be increased for the same size cell.

Thus, there exists a need for thinner battery separators with low shrinkage and/or heat stability.

### SUMMARY

This application is to a coated battery separator that comprises a battery separator (or base film) with a porous polymeric coating on at least one side thereof. The polymer in the porous polymeric coating has a high thermal decomposition temperature. For example, the decomposition temperature may be greater than 200° C., 250° C., 300° C., 350° C., or 400° C.

In one aspect, a coated battery separator comprising a battery separator and a porous coating on at least one side thereof is described. The porous coating comprises a polymer comprising an amide functional group. The amide group may be cyclic or non-cyclic. In some embodiments, the polymer comprising an amide group is poly (N-vinylacetamide).

In some embodiments, the porous coating mainly comprises the polymer comprising an amide functional group or blends of the polymer comprising an amide functional group and at least one other polymer. In some embodiments, the porous coating comprises the polymer comprising an amide functional group and a ceramic. The amount of ceramic is not limited and may be less than 50% or less than 30%

In some embodiments, the porous coating has a thickness less than 5 microns or less than 2 microns.

The coated battery separator may exhibit an MD shrinkage less than 1% at 120° C. MD shrinkage at 150° C. may be less than 5%.

The porous coating, in some embodiments, may have an adhesive coating formed on top of it. The adhesive coating may comprise a sticky polymer. In some embodiments, the porous coating may further comprise a sticky polymer.

In another aspect, a method is described for forming the coated battery separator described herein. The method may comprise providing an aqueous coating slurry comprising the polymer comprising an amide functional group. In some embodiments, the slurry further comprises a compound that generates gas when heated. In another embodiment, the coating slurry further comprises a ceramic.

### DESCRIPTION OF THE DRAWINGS

FIG. 1 is a table including data according to some embodiments described herein.

FIG. 2 is a graph including data according to some embodiments described herein.

FIG. 3 is an SEM of a coated separator according to some embodiments described herein.

FIG. 4 is an SEM of the coating of the coated separator according to some embodiments disclosed herein.

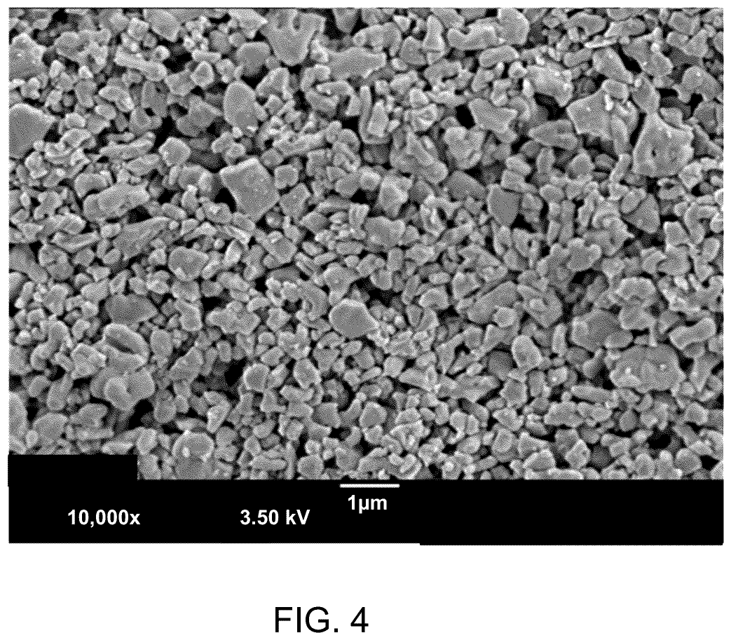

### DESCRIPTION

Described herein is a coated battery separator comprising: 1) a battery separator; and 2) a porous polymeric coating. The porous polymeric coating may be coated on one or both sides of the battery separator. In one preferred embodiment, the coated battery separator exhibits an MD shrinkage less than 1%, less than 0.9%, less than 0.8%, less than 0.7%, less than 0.6%, less than 0.5%, less than 0.4%, less than 0.3%, less than 0.2%, or less than 0.1%. The coated battery separator, in preferred embodiments, exhibits MD shrinkage at 150° C. less than 5%, less than 4%, less than 3%, less than 2%, or less than 1%. For battery safety, it is important that shrinkage is as low as possible at high temperatures. If shrinkage is high, at high temperatures the separator may shrink and expose the electrodes to one another resulting in a short circuit, thermal runaway, or explosion.

### Battery Separator

The battery separator (or base film or polymer membrane) of the coated battery separator described herein is not so limited. However, as understood by those skilled in the art, a battery separator should be electrically insulating and capable of allowing ions to pass across it, i.e, ionically conductive. In some instances, a separator may need to be soaked in electrolyte to become ionically conductive, but in some cases, the separator may be ionically conductive without soaking the battery separator in electrolyte.

The battery separator may be porous or non-porous. In some preferred embodiments described herein, the battery separator may be porous, nanoporous, microporous, or macroporous. In particularly preferred embodiments, the battery separator may have an average pore size less than 1 micron. In some embodiments, the average pore size may be less than 0.9 microns, less than 0.8 microns, less than 0.7 microns, less than 0.6 microns, less than 0.5 microns, less than 0.4 microns, less than 0.3 microns, less than 0.2 microns, or less than 0.1 microns.

The battery separator may be made of a thermoplastic polymer or a blend comprising a thermoplastic polymer. In some preferred embodiments, the thermoplastic polymer is a polyolefin. In some particularly preferred embodiments, the polyolefin may be a homo-polymer or co-polymer of polyethylene or a homo-polymer or co-polymer of polypropylene.

The batter separator may comprise one layer (monolayer), two layers (bi-layer), three layers (tri-layer), or more than three layers (multi-layer).Each layer of the battery separator may be made of the same compositions or different composition.

The battery separator may have a thickness of between 1 to 20 microns, 1 to 19 microns, 1 to 18 microns, 1 to 17 microns, 1 to 16 microns, 1 to 15 microns, 1 to 14 microns, 1 to 13 microns, 1 to 12 microns, 1 to 11 microns, 1 to 10 microns, 1 to 9 microns, 1 to 8 microns, 1 to 7 microns, 1 to 6 microns, 1 to 5 microns, 1 to 4 microns, 1 to 3 microns, or 1 to 2 microns. Preferred thicknesses may be in a range from 5 to 12 microns.

In preferred embodiments, the separator described herein is flat or planar. It does not comprise ribs or other protrusions. However, the separator may comprise ribs or protrusions if the same is compatible with the battery that the separator is used in.

The battery separator or base film may be a dry process polymer membrane such as a monolayer or multiple layer dry process polymer membrane.

The battery separator described herein is coated. In some preferred embodiments, it may comprise only the porous polymeric coating described herein, and the porous polymeric coating may be provided directly onto one or both sides of the separator. In some embodiments, the coated battery separator may be a multi-functional coated separator (MFS). In other embodiments, the coated separator may be a multiple-layer coatings separator (MCS). Here, additional coatings may be provided above or underneath the porous polymeric coating described herein.

### Porous Polymeric Coating

The porous polymeric coating may comprise, consist of, or consist essentially of one or more polymers having a high thermal decomposition temperature. For example, the decomposition temperature may be greater than 200° C., 225° C., 250° C., 275° C., 300° C., 325° C., 350° C., 375° C. or 400° C. Other polymers may also be included in the coating in addition to the polymer having a high thermal decomposition temperature.

In preferred embodiments, the polymer having a high thermal decomposition temperature comprises a cyclic or non-cyclic amide group (NH₂—C═O). The hydrophilic amide group can dissolve well in water, and will have strong interactions with ceramics as described herein. In particularly preferred embodiments, the polymer is soluble, freely soluble, or very soluble in water. For purposes herein, a water-soluble polymer includes any polymer that would be characterized as “very soluble,” “freely soluble,” or “soluble” according to Table 1 below.

The pore size of the coating may be between 0.5 and 5 microns, between 1 to 5 microns, between 1 to 4 microns, between 1 to 3 microns, or between 1 to 2 microns.

TABLE 1

| | Parts of water solvent | Solubility |
|---|---|---|
| Solubility | required for 1 part of | Range in water |
| in water | solute | (mg/ml) |
| very soluble | <1 | ≥1000 |
| freely soluble | from 1 to 10 | 100-1000 |
| soluble | from 10 to 30 | 33-100 |
| sparingly soluble | from 30 to 100 | 10-33 |
| slightly soluble | from 100 to 1000 | 1-10 |
| very slightly soluble | form 1000 to 10000 | 0.1-1 |
| practically insoluble | ≥10000 | <0.1 |

For example, the polymer may be polylactam polymers, polyvinylpyrrolidone (PVP) polymers, poly (N-vinylacetamide) (PNVA), and the like. In some particularly preferred embodiments, the polymer may be PNVA homopolymer or copolymer. Compared to PVP, PNVA and a PNVA copolymer (NVA/sodium acrylate copolymer) exhibit less decomposition in air when exposed to air having a temperature of 250° C. for one hour.

As mentioned above, the polymeric coating is a porous polymeric coating. However, simply coating the aforementioned polymers onto the battery separator will not result in a porous coating. In fact, the coating will be non-porous as indicated by a JIS Gurley measurement of infinity for the coated separator. Instead, additional components must be added to the coating slurry and/or additional processing steps must be taken to make the coating porous. A porous coating is preferable to a non-porous coating. For example, a porous coating may provide a tortuous path that inhibits or slows the growth of dendrites in a secondary battery. Dendrites can cause short circuits, thermal runaway, or explosions.

In some embodiments, the porous polymeric coating described herein may be formed by providing a layer of coating slurry on one or two sides of a battery separator (or base film or polymer membrane) as described herein. The coating slurry may comprise the polymer having a high thermal decomposition temperature (e.g., the polymer having a cyclic or non-cyclic amide functional group) and a compound that generates gas when heated. For example, the compound may generate any one of H₂O, CO₂, and NH₃ gases when heated. An exemplary compounds include ammonium bicarbonate, sodium bicarbonate, potassium bicarbonate, and the like. After the coating slurry is provided, heat is applied to the layer of slurry and the gases generated create pores in the layer. Some of the gas generating compound may remain in the layer, or it will be gone.

In some embodiments, the porous polymeric coating described herein may be formed by providing a layer of coating slurry on one or two sides of a battery separator as described herein. The coating slurry may comprise the polymer having a high thermal decomposition temperature (e.g., the polymer having a cyclic or non-cyclic amide functional group) and a solvent pore former. After the coating slurry is provided, the solvent pore former may evaporate to form pores. Heat may be applied to speed up evaporation, but is not necessary. Exemplary solvent pore formers may include water, isopropyl alcohol, ethanol, methanol, and the like.

In some embodiments, the porous polymeric coating may be formed by providing a layer of coating slurry on one or two sides of a battery separator as described herein. The coating slurry may comprise the polymer having a high thermal decomposition temperature (e.g., the polymer having a cyclic or non-cyclic amide functional group) and a ceramic material. The ceramic material may be present in the final coating in an amount of 50% or less, 40% or less, 30% or less, 20% or less, or 10% or less. After the layer of slurry is applied, some ceramic material may be removed to form pores in the layer. For example acid etching may be used to remove the ceramic material. An example of a useful acid is HF. Exemplary ceramic material may include one or more selected from SiO₂, Al₂O₃, CaCO₃, TiO₂, SiS₂, SiPO₄, boehmite, and the like, and combinations thereof.

In some embodiments, the porous polymeric coating may be formed by providing a layer of coating slurry on one or two sides of a battery separator as described herein. The coating slurry may comprise the polymer having high thermal decomposition temperature (e.g., the polymer having a cyclic or non-cyclic amide functional group). After the layer of coating slurry is provided, the layer may be etched to form pores.

In some preferred embodiments, the porous polymeric coating may have a thickness from 0.1 to 5 microns, from 0.5 to 4 microns, from 0.5 to 3 microns, from 0.5 to 2 microns, or from 0.5 to 1 micron. In particularly preferred embodiments, the coating thickness may be 2 microns or less, 1.5 microns or less, or 1 micron or less.

Adding the porous polymeric coating to the battery separator as described herein results in a JIS Gurley increase of between 10 and 100 seconds to the Gurley of the uncoated separator. For example, if the uncoated separator has a JIS Gurley of 100 seconds, the coated separator will have a JIS Gurley between 110 to 200 seconds. In particularly preferred embodiments, the addition of the porous polymeric coating will result in a JIS Gurley increase less than 50 seconds, less than 40 seconds, less than 30 seconds, or less than 10 seconds.

In some embodiments, an MCS is formed, an additional layers may be formed underneath or on top of the porous polymeric coating described herein.

For example, in some embodiments, an adhesive coating may be provided on top of a porous polymeric coating as described herein. An adhesive coating, as understood by those skilled in the art, allows for better adhesion between the separator and the electrodes of the secondary battery. When the separator adheres to the electrodes better, manufacture of the secondary battery may become more efficient because the separator-electrode alignment is fixed and does not become misaligned easily. Examples of materials that the adhesive coating may comprise, consist of, or consist essentially of include PVDF homopolymers, PVDF copolymers, PEO, and the like. The adhesive coating may be a continuous or non-continuous coating. It may cover a portion of the underlying layer or surface, or it may cover the entire underlying layer or surface.

In other embodiments, a ceramic coating may be provided underneath or on top of the porous polymeric coating described herein. A ceramic coating, as understood by those in the art, comprises from 80% to 100% ceramic, and preferably from 90% to 100% ceramic, most preferably from 95% to 100% ceramic. A ceramic coating may also comprise a binder and other known additives.

In one embodiment, the coated separator may comprise a ceramic coating, a porous polymeric coating as described herein, and an adhesive coating provided, in that order, on at least one side of the battery separator. In other embodiments, the coated separator may comprise a porous polymeric coating as described herein, a ceramic coating, and an adhesive coating provided, in that order, on at least one side of the battery separator.

### Method

A method for forming the coated battery separator described herein may comprise providing a coating slurry on at least one side of a battery separator as described herein. The coating slurry may comprise the polymer having high thermal decomposition temperature (e.g., the polymer having a cyclic or non-cyclic amide functional group). In addition, the coating slurry may comprise one or more of ceramics as described herein, gas-generating compounds as described herein, and other known additives. In some embodiments, the slurry may comprise the polymer having high thermal decomposition temperature and one or more gas-generating compounds. In some embodiments, the slurry may comprise the polymer having high thermal decomposition temperature and a ceramic. In some embodiments, the slurry may comprise the polymer having high thermal decomposition temperature, a ceramic, and one or more gas-generating compounds.

The coating slurry also includes a solvent. For example, the solvent may be aqueous or non-aqueous, e.g., an organic solvent. An aqueous solvent comprises mainly water, but may also include a water-soluble additive such as an alcohol, e.g., methanol, ethanol, propanol, etc. The water-soluble additive is preferably added in an amount of 20% or less, 15% or less, 10% or less, or 5% or less.

After the coating slurry is provided, additional steps may be performed to form pores in the layer of coating slurry.

For example, in embodiments where the slurry includes gas-generating compounds, the layer of coating slurry may be heated to a temperature at which these gas-generating compounds generate gas, which forms pores in the layer. For example, if ammonium bicarbonate is used, the layer may be heated to a temperature of about 50° to 100° C.

In embodiments where a ceramic is added, a further step may be performed to remove some or all of the ceramic form pores in the layer. For example, if SiO₂ is used as the ceramic material, HF can be used to remove the SiO₂ to form pores. In embodiments where enough ceramic is added to the slurry, etching will not be necessary to form pores. Amounts greater than 50% would be needed for this.

In some embodiments, pores may be generated in the layer by ion-beam etching and the like.

### EXAMPLES

MD Shrinkage is measured by cutting a 5 cm×5 cm sample, measuring the machine direction (MD) length of the sample (L₀), placing the sample in an oven at 120° C. or 150° C. one hour, re-measuring the MD length after heating (L₁), and calculating the percent shrinkage ((L₀−L₁)/(L₀))×100.
Example 1.1 and 1.2 include a 13 micron polypropylene battery separator coated with a porous 3 micron coating comprising alumina and PNVA (100:1-5)
Example 2.1 and 2.1 include a 10 micron polypropylene battery separator coated with a 2 micron porous coating comprising alumina and PNVA (100:1-5)
Example 3.1 and 3.2 include a 14 micron co-extruded polyolefin membrane and a 2 micron porous coating comprising alumina and PNVA (100:1-5)

Comparative Example includes a 10-15 micron polyolefin separator with a coating having a thickness from 2-5 microns with alumina and acrylic binder (100:1-5).

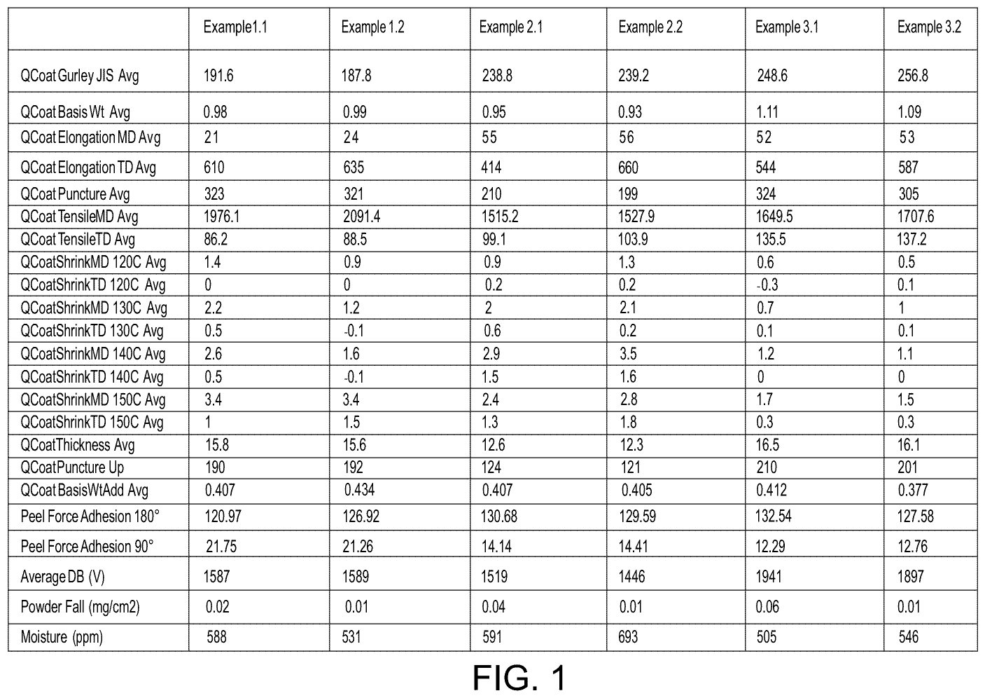

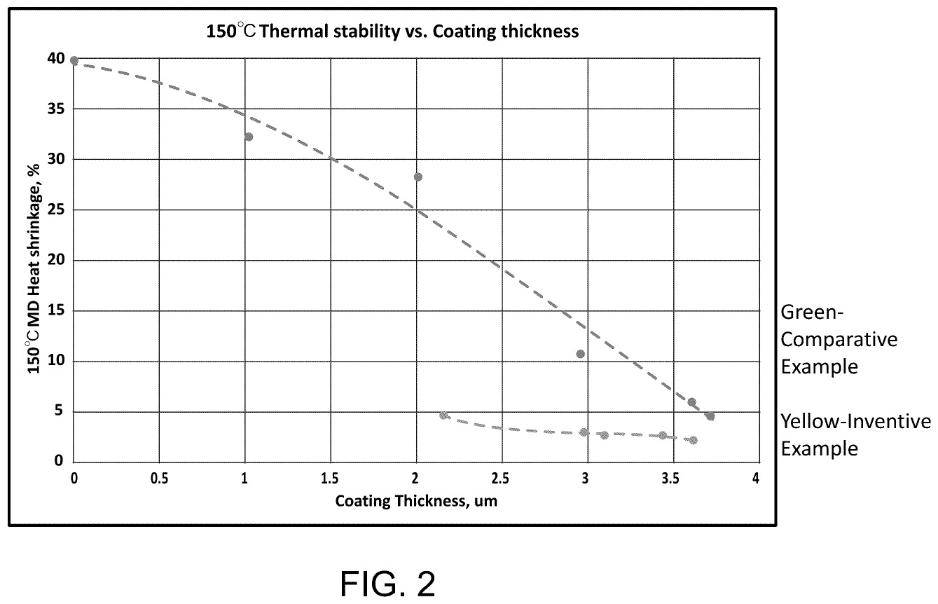

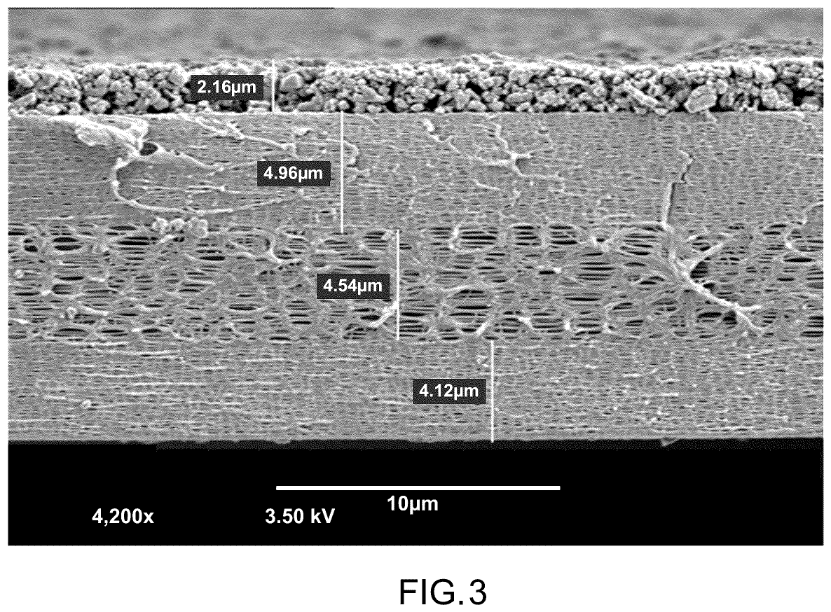

Each sample was tested, and data is recorded in the Table on FIG. 1. FIG. 2 is a graph comparing shrinkage at a given coating thickness for Example 1.1 and Comparative Example. FIG. 3 is an SEM of Example 1.1.

In selected embodiments, aspects or objects of the present invention or disclosure, there is provided a new or improved coated battery separator (which may address some of the prior separator issues of shrinkage and/or heat stability), comprising a battery separator (or base film or polymer membrane) and a porous coating on at least one side of the battery separator, wherein the porous coating comprises a polymer comprising an amide functional group. In certain embodiments, the coated battery separator may be a multi-functional coated separator (MFS), or a multiple-layer coatings separator (MCS) having additional coatings provided above or underneath the porous coating or porous polymeric coating.

1. A coated battery separator, comprising:
a battery separator; and
a porous coating on at least one side of the battery separator, wherein the porous coating comprises a polymer comprising an amide functional group.

2. The coated battery separator of claim 1, wherein the porous coating has a thickness less than 5 microns.

3. The coated battery separator of claim 1, wherein the porous coating has a thickness less than 2 microns.

4. The coated battery separator of claim 1, wherein the amide group is a cyclic amide group or a non-cyclic amide group.

5. The coated battery separator of claim 4, wherein the amide group is a cyclic amide group.

6. The coated battery separator of claim 4, wherein the amide group is a non-cyclic amide group.

7. The coated battery separator of claim 1, wherein the polymer comprising an amide functional group is Poly (N-vinylacetamide) PNVA homopolymer or copolymer.

8. The coated battery separator of claim 1, wherein the porous coating mainly comprises the polymer comprising an amide functional group or blends of the polymer comprising an amide functional group and at least one other polymer.

9. The coated battery separator of claim 1, wherein the porous coating further comprises a ceramic.

10. The coated battery separator of claim 9, wherein the ceramic is present in an amount less than 50%.

11. The coated battery separator of claim 9, wherein the ceramic is present in an amount less than 30%.

12. The coated battery separator of claim 1, exhibiting an MD shrinkage less than 1% at 120° C.

13. The coated battery separator of claim 2, exhibiting an MD shrinkage less than 1% at 120° C.

14. The coated battery separator of claim 3, exhibiting an MD shrinkage less than 1% at 120° C.

15. The coated battery separator of claim 1, further comprising an adhesive coating on top of the porous coating.

16. The coated battery separator of claim 8, further comprising an adhesive coating on top of the porous coating.

17. The coated battery separator of claim 9, further comprising an adhesive coating on top of the porous coating.

18. The coated battery separator of claim 8, wherein the porous coating comprises a sticky polymer.

19. The coated battery separator of claim 9, wherein the porous coating further comprises a sticky coating.

20. A method for forming the coated battery separator of claim 1, comprising providing an aqueous coating slurry comprising the polymer comprising an amide functional group and providing a battery separator (or base film or polymer membrane) to be coated on at least one side with the aqueous coating slurry.

21. The method of claim 20, wherein the coating slurry further comprises a compound that generates gas when heated.

22. The method of claim 20, wherein the coating slurry further comprises a ceramic.
